(19) United States
(12) Patent Application Publication
(10) Pub. No.: US 2006/0048170 A1
(43) Pub. Date: Mar. 2, 2006

(54) Apparatus and method for loading/ejecting a disc magazine into/from a chassis

(75) Inventor: Jui Chiang Lin, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/043,162

(22) Filed: Jan. 27, 2005

(30) Foreign Application Priority Data
Aug. 27, 2004 (TW) 093125959

(51) Int. Cl. G11B 7/085; G11B 21/08; G11B 17/04

(52) U.S. Cl. 720/619

(57) ABSTRACT

An apparatus for loading/ejecting a disc magazine into/from a chassis comprises a loading sensor installed in the chassis for sensing the disc magazine, a transmission mechanism comprising a driving gear set and a rack disposed on the surface of the disc magazine. The loading sensor is disposed to sense the disc magazine so as to actuate the driving gear set of the transmission mechanism. The rack disposed on the surface of the disc magazine is engaged with the driving gear set at this time to drive the disc magazine to be loaded into the chassis. Besides, the disc magazine can be ejected from the chassis by actuating the driving gear set of the transmission train.

This Non-provisional application claims priority under 35 U.S.C. §119(a) on Patent Application No(s). 093125959 filed in Taiwan, Republic of China on Aug. 27, 2004, the entire contents of which are thereby incorporated by reference.

### BACKGROUND OF THE INVENTION

1. Field of the Invention

The present invention relates to an optical storage apparatus with a disc magazine, and more particularly to an apparatus and method for loading/ejecting a disc magazine into/from a chassis of the optical storage apparatus.

2. Description of Related Art

Accompanying the arrival of the digital era, optical discs capable of storing a large amount of data have already become important media for audio-visual playback and data storage. Currently, when a user enjoying audio-visual entertainment or process digital data, reading data from multiple discs is always required so that an optical storage apparatus with a disc magazine used for accepting multiple discs at the same time is developed. A user can choose to read any disc in the disc magazine through a control system by means of the characteristic that the discs can be accepted concurrently in the disc magazine so as to save the time for changing discs.

As FIGS. 1 and 2 show, a manual force must be exerted on the outside of a disc magazine 1 to allow it to be pushed into a chassis 2 of an optical storage apparatus to allow an accepting groove 11 disposed at the bottom of the disc magazine 1 to be successfully engaged with an elastic inverted hook 21 disposed inside of the disc magazine 2. Thereby, the disc magazine 1 can be positioned at an accurate location in the chassis 2 to allow a disc selecting mechanism 3 and hoisting mechanism 4 to be functioned successfully so as to operate in coordination with an optical pickup head to read data.

Because the disc magazine need be pushed into the chassis 2 by hand and the push force is not easy to be controlled, the wear of corresponding components is easily caused owing to an excessive or over-fierce press, and the disc magazine 1 is easy to be jammed in the optical storage apparatus owing the unevenly exerting force by hand.

Thus it is preferred to have a solution that the disc magazine can be moved without a manual force such that the disc magazine can be loaded or ejected automatically into or from the chassis.

### SUMMARY OF THE INVENTION

The present invention provides an apparatus for loading/ejecting a disc magazine into/from a chassis. The apparatus comprises a loading sensor, a transmission mechanism, and a rack. The loading sensor is disposed in the chassis for sensing the disc magazine. The transmission mechanism, comprising a driving gear set. The rack is disposed on the surface of the chassis for being engaged with the driving gear set so that the driving gear set can be driven to move the disc magazine for loading/ejecting the disc magazine into/from the chassis.

Moreover, a guiding element is further installed in the chassis and a guiding groove is disposed on corresponding surface of the disc magazine for guiding the disc magazine to be loaded into/ejected from said chassis along a proper route. The transmission mechanism is installed on the surface inside of the chassis, and the rack is disposed on the surface of the disc magazine corresponding to the transmission mechanism.

The loading sensor can be an optical sensor, a weight sensor or an electric switch.

The present invention also provides a method for loading a disc magazine into a chassis, comprising the following steps: triggering a loading sensor or pressing down a loading button to actuate a transmission mechanism; and driving said transmission mechanism to load said disc magazine into the chassis to a predetermined location.

The present invention further provides a method for ejecting a disc magazine from a chassis, comprising the following steps: actuating said transmission mechanism; and driving said transmission mechanism to eject said disc magazine from said chassis.

### BRIEF DESCRIPTION OF THE DRAWINGS

The present invention can be more fully understood by reference to the following description and accompanying drawings, in which:

FIG. 1 is a prospective view, showing a disc magazine of a prior art;

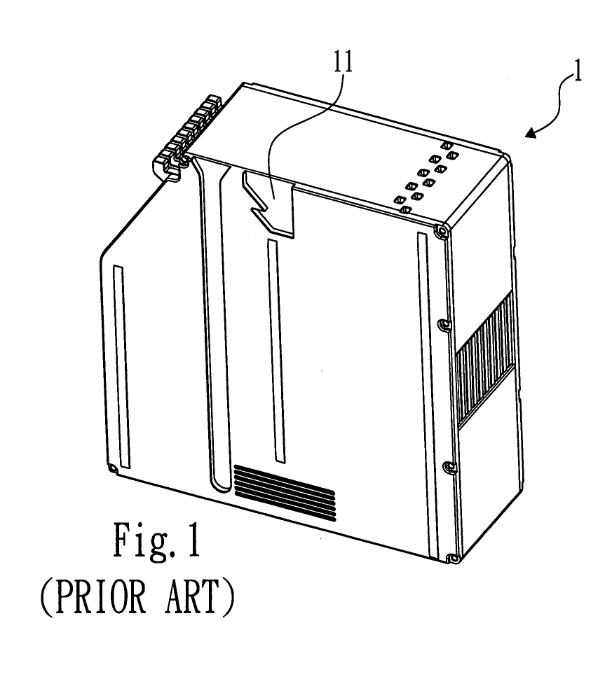

FIG. 2 is a cross sectional view, showing a combination of a chassis and disc magazine according to the prior art;

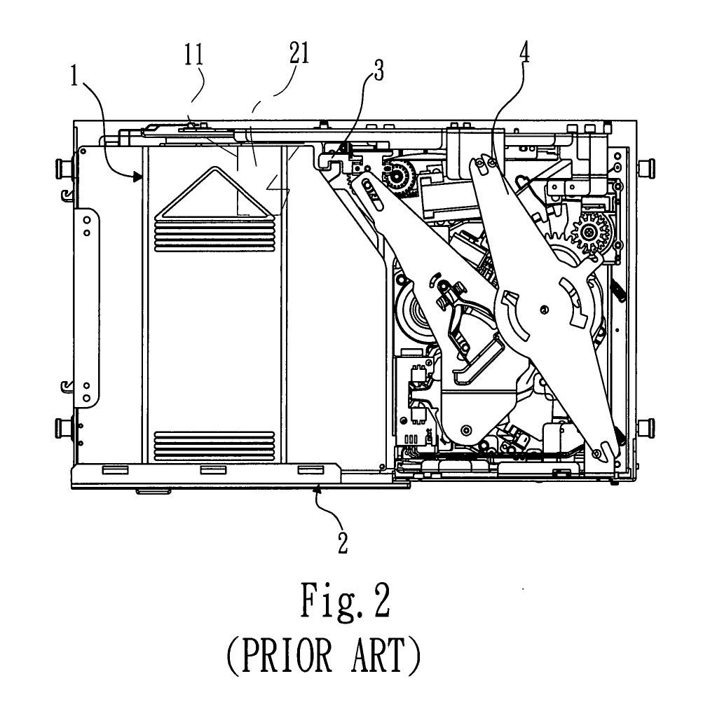

FIG. 3 is a prospective view, showing a chassis of an apparatus for loading/ejecting a disc magazine into/from a chassis according to the present invention;

FIG. 4 is a prospective view, showing a disc magazine of an apparatus for being loaded/ejected into/from a chassis according to the present invention;

FIG. 5 is a flow chart, showing a method for loading a disc magazine into a chassis according to the present invention;

FIG. 6 is a flow chart, showing a method for ejecting a disc magazine from a chassis according to the present invention;

FIG. 7 is a schematic view showing a combination of a chassis and disc magazine of an apparatus for loading/ejecting the disc magzine into/from a chassis according to the present invention; and

FIG. 8 is a schematic view showing a combination of a chassis and disc magazine of an apparatus for loading/ejecting the disc magzine into/from a chassis according to the present invention.

### DETAILED DESCRIPTION OF THE PREFERRED EMBODIMENTS

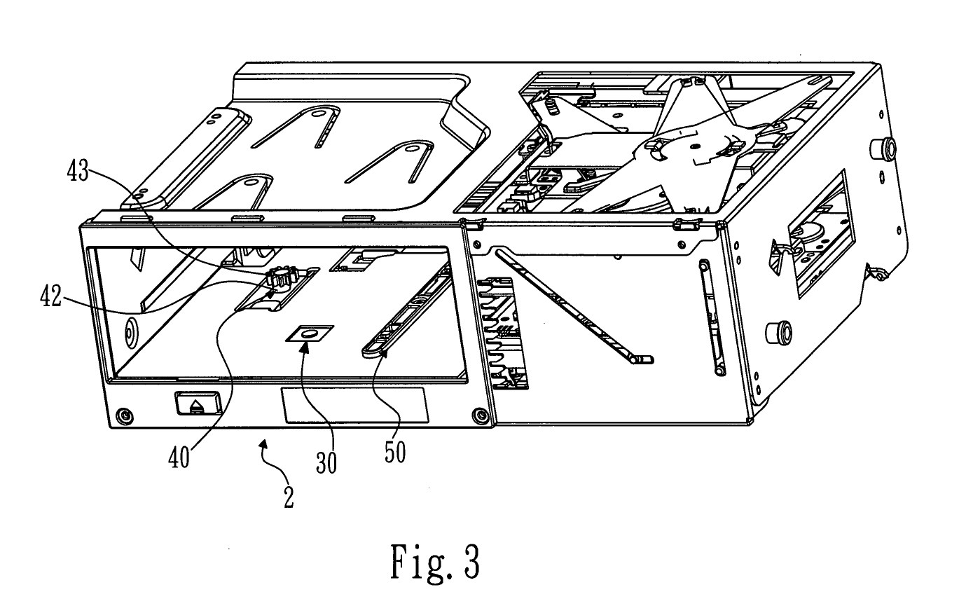

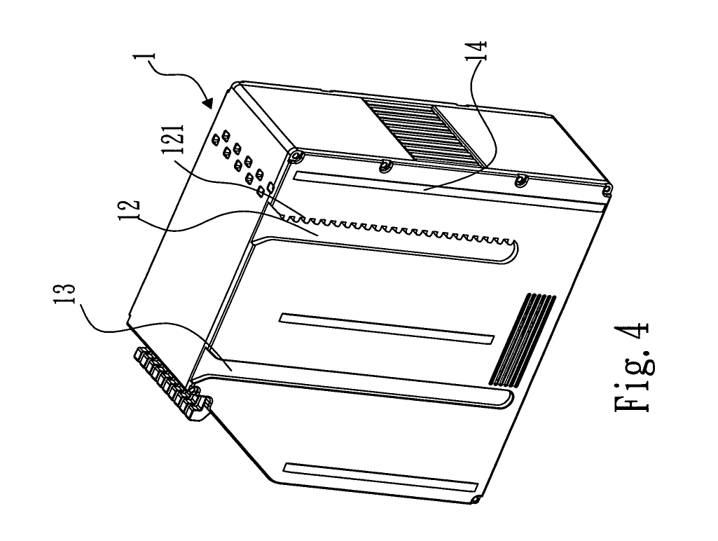

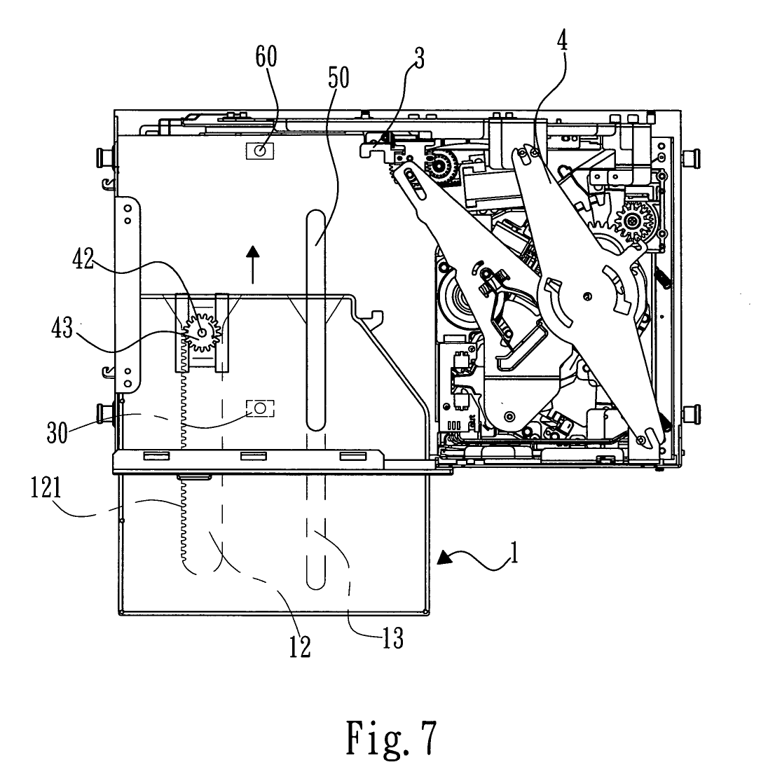

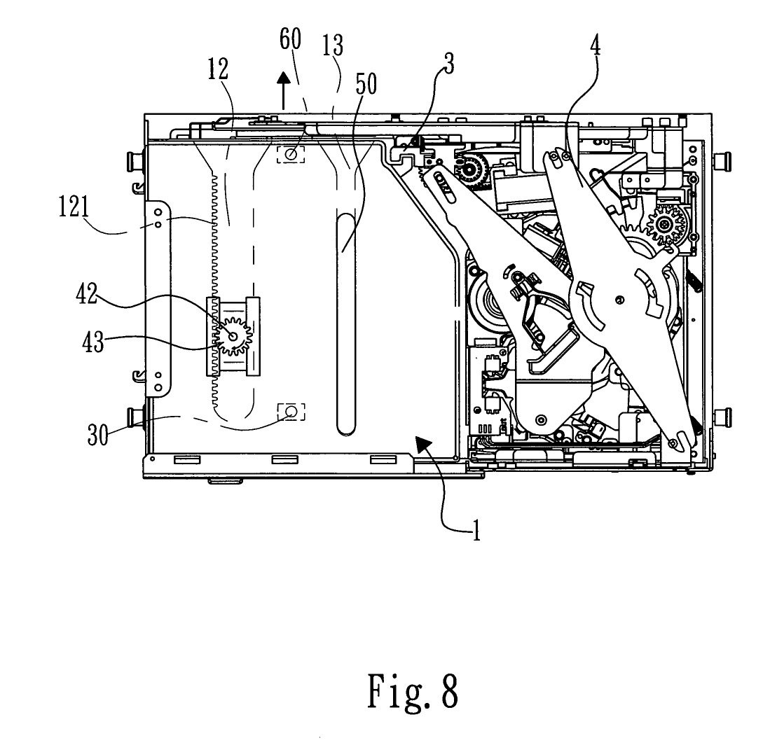

Please refer to FIGS. 3 and 4. FIGS. 3 and 4 are prospective views respectively showing a chassis and disc magazine of an apparatus for loading/ejecting a disc magazine into/from a chassis. As FIG. 3 shows, the apparatus for loading/ejecting a disc magazine into/from a chassis mainly comprises a loading sensor 30, transmission mechanism 40, guiding element 50, braking sensor 60 (as shown in FIGS. 7 and 8) and gear groove 12 disposed at the surface of a disc magazine 1. The loading sensor 30 is disposed at the lower surface inside of a chassis 2 close to the inlet thereof for sensing the disc magazine 1 so that the transmission mechanism 40 is actuated to perform a loading operation. The transmission mechanism 40 driven by a driving motor (not shown in the figures) is installed below the chassis 2, and a power shaft 42 of the driving motor is connected to a gear set 43 so that the gear set 43 is engaged with a rack 121 in the gear groove 12 disposed at the lower surface of the disc magazine 1. Thus the disc magazine 1 can be loaded into the chassis 2 to a predetermined location for the disc selecting mechanism 3 to be able to access the disc magazine 1 properly. The guiding element 50 is disposed on the lower surface inside of the chassis 2, and a guiding groove 13 corresponding to the guiding element 50 is disposed at the lower surface of the disc magazine 1 for matching with the guiding element 50 to guide the disc magazine 1 while performing the ejecting or loading operations. Furthermore, as FIG. 4 shows, a plurality of sliding strips 14 are uniformly disposed on the surface of the disc magazine 1 so as to reduce the friction force between the lower surface of the disc magazine 1 and the bottom of the chassis 2 effectively to allow the disc magazine 1 to be loaded into or ejected from the chassis smoothly through the transmission mechanism 40 mentioned above. The braking sensor 60 is installed in the chassis 2, as shown in FIGS. 7 and 8. Under the situation that the loading operation of the disc magazine 1 is performed, when the disc magazine 1 has already arrived at a predetermined location, the braking sensor 60 can sense the disc magazine 1 and the transmission mechanism 40 is then stopped. Moreover, under the situation that the ejecting operation of the disc magazine 1 is performed, when the loading sensor 30 senses that most portion of the disc magazine 1 has already been ejected from the chassis, the transmission mechanism 40 could be stopped for the convenience of a user further to remove the disc magazine 1.

Although the transmission mechanism 40 and the guiding element 50 mentioned above are disposed on the lower surface inside of the chassis 2, but they also can be disposed on any surface of the chassis 2 such as the upper surface or the side surface inside thereof. The gear groove 12 and guiding groove 13 can be disposed at the locations on the surfaces of the magazine corresponding to the dispositions of the transmission mechanism 40 and the guiding element 50. Though these locations are different, the same actions can still be completed in similar ways.

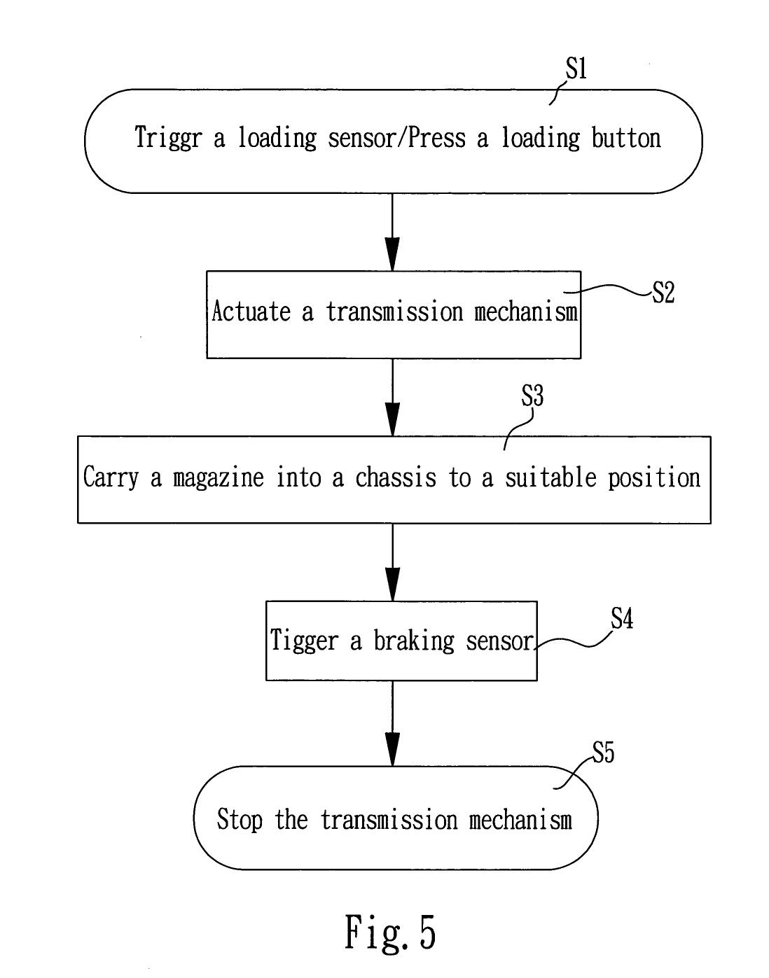

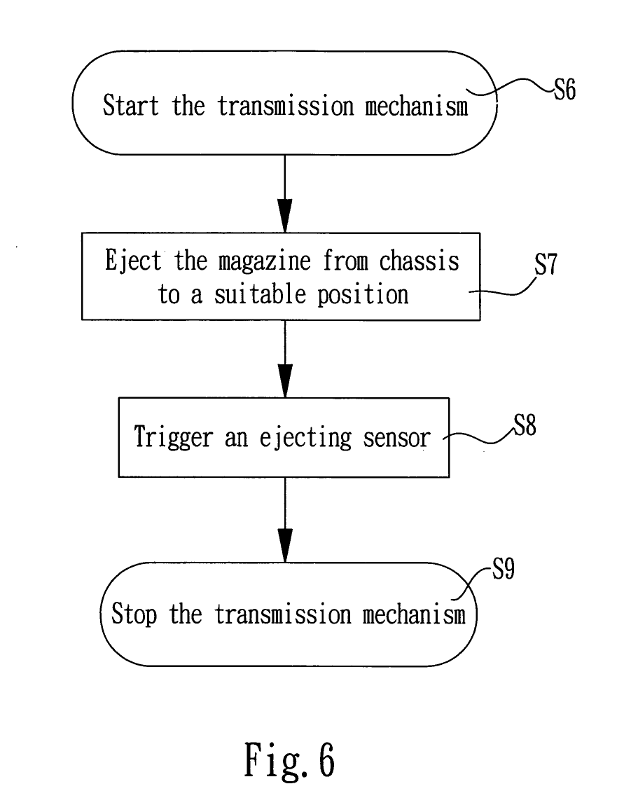

Please refer to FIGS. 5 to 8 that are flow charts and schematic views for illustrating a disc magazine being loaded into or ejected from a chassis according to the present invention. As the flow charts of FIGS. 5 and 6 accompanying FIGS. 7 and 8 show, when the disc magazine 1 is going to be loaded into the chassis 2, the disc magazine 1 is placed at the inlet of the chassis 2, (step S1) with the guiding groove 13 of the disc magazine 1 matched up with the guiding element 50. The disc magazine 1 is then pushed slightly inward the chassis 2 to allow the loading sensor 30 disposed at the inlet of the chassis 2 to respond. When the loading sensor 30 senses the disc magazine 1, the transmission mechanism 40 is then actuated to perform a loading operation. Alternatively, a loading /ejecting button can be pressed down to actuate the transmission mechanism 40 manually to allow the transmission mechanism 40 to be driven to rotate (Step S2). Thus the gear set 43 connected to the transmission shaft 42 of the transmission mechanism 40 is driven to rotate at the direction for loading the magazine 1 into the chassis 2. After the disc magazine 1 is then pushed a little forward into the chassis 2, the rack 121 of the gear groove in the surface of the disc magazine 1 engages with the gear set 43 to drive the disc magazine 1 to be loaded into the chassis 2 (Step S3). The disc magazine 1 can be guided stably along a proper route in the chassis 2 through the guiding groove 13 disposed in the lower surface of the disc magazine 1 cooperating with the guiding element 50. When the disc magazine 1 is moved to a proper location in the chassis 2, the braking sensor 60 can respond to the arrival of the disc magazine 1 (Step S4). When said loading sensor senses said disc magazine, the transmission mechanism 40 is then stopped (Step S5). Thus the disc magazine 1 can be accurately positioned at a proper location in the chassis 2 so as to allow the disc selecting mechanism 3 and elevating mechanism 4 to access discs carried in the disc magazine 1. Besides, the transmission mechanism 40 can also be driven continuously, and the steps S4 and S5 are omitted. Therefore a pull force is continuously exerted on the disc magazine 1 by the torque through the engagement of the gear set 43 and the gear groove 12. Thereby, the disc magazine 1 can be fixed in the chassis 2.

When the disc magazine 1 is going to be ejected from the chassis 2, the transmission mechanism 40 is directly actuated through a system command or by pressing the loading/ejecting button (Step S6) to cause the power axis 42 of the driving motor 41 in the mechanism to rotate at a direction opposite to what during the loading operation. The rack 121 in the disc magazine 1 is driven to cause the disc magazine 1 to be ejected from the chassis 2 (Step S7). The loading sensor 30 disposed at the inlet of the chassis 2 can be used to sense if most of the disc magazine 1 is ejected at this time (Step S8) and further causes the transmission mechanism 40 to stop (Step S9) such that the disc magazine 1 can be kept staying on the chassis 2 for the convenience of a user. Moreover, an ejecting sensor different from the loading sensor 30 can further be installed especially for stopping the transmission mechanism 40 when the disc magazine is conveyed to a proper position during the ejecting operation.

The sensor mentioned above such as the loading sensor 30 or the braking sensor 60 can be a weight sensor. When the disc magazine passed through the weight sensor, the weight sensor can detect the changing of weight-loading and generate an electric signal to indicate if the magazine is currently at the sensing position. The sensor can also be an electric switch or optical sensor so that an electric signal can be generated owing to the touching of the electric switch or the blocking of the optical sensor when the disc magazine is passing the sensor.

Because a transmission mechanism mechanically guides the disc magazine to be loaded into/ejected from the chassis, the operation for executing the loading or ejecting of the disc magazine can be simpler and more efficient in time and power consumption according to the apparatus and the method for loading/ejecting a disc magazine into/from a chassis of the present invention. Besides, an accepting groove and an elastic inverted hook 21 used for fixing a conventional disc magazine and chassis are not needed according to the apparatus and the method for loading/ejecting a disc magazine into/from a chassis of the present invention. Therefore, the malfunction of the hook elements caused by elastic fatigue after a long period of use can be avoided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for loading/ejecting a disc magazine into/from a chassis, comprising:
a loading sensor, disposed in said chassis for sensing said disc magazine;
a transmission mechanism, comprising a driving gear set; and
a rack, disposed on the surface of said chassis for being engaged with said driving gear set so that said driving gear set is driven to move the said disc magazine for loading/ejecting said disc magazine into/from said chassis;
wherein during performing an loading operation, when said loading sensor senses said disc magazine, said driving gear set of said transmission mechanism is actuated to load said disc magazine into said chassis.

2. The apparatus according to claim 1, wherein when a braking sensor is further installed in said chassis, and said transmission mechanism is stopped when said braking sensor senses said disc magazine.

3. The apparatus according to claim 1, wherein a guiding element is further installed in said chassis and a guiding groove is disposed at corresponding surface of said disc magazine for guiding said disc magazine to be loaded into/ejected from said chassis along a proper route.

4. The apparatus according to claim 1, wherein said transmission mechanism is installed on the surface inside of said chassis, and said rack is disposed on the surface of said disc magazine corresponding to said transmission mechanism.

5. The apparatus according to claim 4, wherein said transmission mechanism is installed on the lower surface inside of said chassis, and said rack is disposed on the lower surface of said disc magazine.

6. The apparatus according to claim 1, wherein said loading sensor is an optical sensor, a weight sensor or an electric switch.

7. The apparatus according to claim 2, wherein said braking sensor is an optical sensor, a weight sensor or an electric switch.

8. The apparatus according to claim 1, wherein a plurality of sliding strips are disposed on the lower surface of said disc magazine.

9. A method for loading a disc magazine into a chassis, comprising the following steps:
triggering a loading sensor or pressing down a loading button to actuate a transmission mechanism; and
driving said transmission mechanism to load said disc magazine into the chassis to a predetermined location.

10. The method according to claim 9, further comprising the following step:
stopping said transmission mechanism when a braking sensor senses said disc magazine.

11. The method according to claim 9, wherein said loading sensor is an optical sensor, a weight sensor or an electric switch.

12. The method according to claim 9, further comprising the following step:
driving the transmission mechanism continuously to provide a pull force on the disc magazine.

13. A method for ejecting a disc magazine from a chassis, comprising the following steps:
actuating said transmission mechanism; and
driving said transmission mechanism to eject said disc magazine from said chassis.

14. The method according to claim 13, further comprising the following step:
stopping said transmission mechanism when an ejecting sensor senses that most of said disc magazine has been ejected.

15. The method according to claim 14, wherein said loading sensor is an optical sensor, a weight sensor or an electric switch.
